(19) United States
(12) Patent Application Publication
(10) Pub. No.: US 2026/0355683 A1
(43) Pub. Date: Nov. 12, 2026

(54) A CENTRIFUGAL SEPARATOR FOR CLEANING GAS

(71) Applicant: Alfdex AB, LANDSKRONA (SE)

(72) Inventor: Patrik JONSSON, HUDDINGE (SE)

(73) Assignee: Alfdex AB, LANDSKRONA (SE)

(21) Appl. No.: 19/135,146

(22) PCT Filed: Nov. 15, 2023
(86) PCT No.: PCT/EP2023/081834

§ 371 Date: Jun. 3, 2025

(30) Foreign Application Priority Data
Dec. 14, 2022 (EP) 22213547.7

(51) Int. Cl. B01D 53/24; B04B 5/08; B04B 7/04

(52) U.S. Cl. CPC B01D 53/24; B04B 5/08; B04B 7/04

(57) ABSTRACT

The present invention provides a centrifugal separator (1) for cleaning gas containing contaminants. The centrifugal separator comprising a stationary casing (2), enclosing a separation space (3) through which a gas flow is permitted, a gas inlet (20) arranged to permit supply of the gas to be cleaned into the stationary casing (2), a rotating member (7) comprising a plurality of separation members (9) arranged in the separation space (3) and being arranged to rotate around a first axis (X) of rotation, a gas outlet (28) arranged to permit discharge of cleaned gas out from the stationary casing (2), a drainage outlet (29) arranged in the stationary casing (2) and configured to permit discharge of liquid contaminants that have been separated from the gas out from the stationary casing, a drive unit (26) comprising a drive member (18) for rotating the rotating member (7), and a further module. The centrifugal separator (1) further comprises a compression seal (100) arranged for sealing stationary casing (2) against said further module and comprising at least one elongated flap (122) and at least one recess (112), the compression seal (100) having a continuous extension around a second axis (Y), wherein said at least one elongated flap (122) is arranged in said at least one recess (112) such that a compression force sealing is achieved by means of the flap surface being in contact with the recess surface.

### FIELD OF THE INVENTION

The present invention relates to the field of centrifugal separators for cleaning a gas containing liquid contaminants. In particular, the present invention relates to a separator for cleaning crankcase gases of a combustion engine from oil particles.

### BACKGROUND OF THE INVENTION

It is well known that a mixture of fluids having different densities may be separated from one another through use of a centrifugal separator. One specific use of such a separator is in the separation of oil from gas vented from a crankcase forming part of an internal combustion engine.

With regard to this specific use of separators, there can be a tendency for the high-pressure gas found in the combustion chambers of an internal combustion engine to leak past the associated piston rings and into the crankcase of the engine. This continuous leaking of gas into the crankcase can lead to an undesirable increase of pressure within the crankcase and, as a consequence, to a need to vent gas from the casing. Such gas vented from the crankcase typically carries a quantity of engine oil (as droplets or a fine mist), which is picked up from the reservoir of oil held in the crankcase.

In order to allow vented gas to be introduced into the inlet system without also introducing unwanted oil (particularly into a turbocharging system wherein the efficiency of the compressor can be adversely affected by the presence of oil), it is necessary to clean the vented gas (i.e. to remove the oil carried by the gas) prior to the gas being introduced into the inlet system. This cleaning process may be undertaken by a centrifugal separator, which is mounted on or adjacent the crankcase and which directs cleaned gas to the inlet system and directs separated oil back to the crankcase. An example of such a separator is disclosed e.g. in U.S. Pat. No. 8,657,908.

Separators for cleaning crankcase gas need to be tightly sealed so that gases and liquids do not leak to the surrounding environment and to ensure that there is no unwanted leakage between different compartments of the separator. Sealing of the stationary housing is normally achieved by tightening two parts together, e.g. using screws, together with the use of rubber seals, such as O rings. In a finished product rubber seals may be well hidden within the structure, which means that it may be difficult to check and control the function or the presence of such seal. This may be a problem in the high-volume production of crankcase gas separators. Further, the use of rubber seals further makes it difficult to automatically produce the separator and a manual assembly may damage the rubber seals, so the sealing function is not adequately obtained.

There is thus a need in the art for improved sealing functions of a centrifugal separator.

### SUMMARY OF THE INVENTION

It is an object of the invention to at least partly overcome one or more limitations of the prior art. In particular, it is an object to provide a centrifugal separator with an enhanced sealing function of the stationary casing that also improves the manufacturing process.

As a first aspect of the invention, there is provided a centrifugal separator for cleaning gas containing contaminants, the centrifugal separator comprising
a stationary casing, enclosing a separation space through which a gas flow is permitted,
a gas inlet arranged to permit supply of the gas to be cleaned into the stationary casing,
a rotating member comprising a plurality of separation members arranged in the separation space and being arranged to rotate around a first axis (X) of rotation,
a gas outlet arranged to permit discharge of cleaned gas out from the stationary casing,
a drainage outlet arranged in the stationary casing and configured to permit discharge of liquid contaminants that have been separated from the gas out from the stationary casing,
a drive unit comprising a drive member for rotating the rotating member, and
a further module,
wherein the centrifugal separator further comprises
a compression seal arranged for sealing the stationary casing against said further module and comprising at least one elongated flap and at least one recess, the compression seal having a continuous extension around a second axis (Y);
wherein said at least one elongated flap is arranged in said at least one recess such that a compression force sealing is achieved by means of the flap surface being in contact with the recess surface.

This design achieves a simple yet reliable sealing capacity that is sufficient for centrifugal separators for cleaning gas containing liquid contaminants. Further, the first aspect of the invention decreases the risk of leaving out a seal, such as a separate piece of sealing, e.g. an O ring in connection to the stationary housing during production, which is something that is difficult to test or check after assembly of a whole separator. By not using a separate piece of sealing and thus risk to leave it out, the time of manual assembly and verification is decreased.

As used herein, the term “axially” denotes a direction which is parallel to a first rotational axis (X). Accordingly, relative terms such as “above”, “upper”, “top”, “below”, “lower”, and “bottom” refer to relative positions along the first rotational axis (X). Correspondingly, the term “radially” denotes a direction extending radially from the first rotational axis (X). A “radially inner position” thus refers to a position closer to the first rotational axis (X) compared to “a radially outer position”. A radial plane is a plane having its normal parallel to the first axis of rotation (X). An axial plane is a plane having its normal perpendicular to the first axis of rotation (X).

The contaminants in the gas may comprise liquid contaminants, such as oil, and soot.

Consequently, the centrifugal separator may be for separating liquid contaminants, such as oil, from gas. The gas may be crankcase gas of a combustion engine. However, the centrifugal separator may also be suitable for cleaning gases from other sources, for instance the environment of machine tools which frequently contains large amounts of liquid contaminants in the form of oil droplets or oil mist.

The stationary casing of the centrifugal separator may comprise a surrounding side wall, and first and second walls, which enclose the separation space. The stationary casing may have a cylindrical shape with circular cross section having a radius from the first axis (X) of rotation to the surrounding side wall. This radius may be constant at least with respect to a major part of the circumference of the surrounding side wall. The first and second walls may thus form an upper wall and a lower end wall of the cylindrical shaped casing. The stationary casing may also be slightly conical.

The gas inlet of the centrifugal separator may be arranged through the first wall or through the upper part, thus at the top of the separator, such that gas entering through the gas inlet is directed to the separation space. The inlet may be centred around the first axis of rotation (X). The gas inlet may be connected to an upper opening wall section. The inlet may extend radially or axially from the centrifugal separator, or in any other direction therebetween.

The rotating member is arranged for rotation during operation by means of the drive member. The rotating member comprises a plurality of separation members arranged in the separation space. The separation members of the rotating member are examples of surface-enlarging inserts that promote separation of contaminants from the gas. The separation members may be a stack of separation discs. The separation discs of the stack may be frustoconical. A frustoconical disc may have a planar portion extending in a plane that is perpendicular to the axis of rotation, and a frustoconical portion that may extend upwards or downwards. The planar portion may be closer to the rotational axis than the frustoconical portion. Further, the discs of the stack may be radial discs, in which substantially the whole disc extends in a plane that is perpendicular to the axis of rotation.

It is also to be understood that the separation members, such as separation discs, not necessarily have to be arranged in a stack. The separation space may for example comprise axial discs, or plates that extend around the axis of rotation. The axial discs or plates may be planar, i.e. extending in planes that are parallel to the axis of rotation. The axial discs or plates may also have a slightly or significantly curved shape, such as an arcuate or spiral shape, as seen in a radial plane.

The rotating member may be journaled within the stationary casing via at least one bearing, such as via an upper and lower bearing arranged axially above and below the stack of separation members, respectively.

The drainage outlet may be arranged in the lower portion of the stationary casing, such as arranged in the second wall, e.g. at the bottom of the separator. Thus, the drainage outlet may be arranged centrally in a wall opposite the upper part through which, or at which, the inlet is arranged. The drainage outlet of the centrifugal separator may further be formed by several spot shaped through holes of the stationary casing or by a single drainage passage. The drainage outlet may be arranged at the axis of rotation or centred around the axis of rotation. The drainage outlet may also be in an annular collection groove at the inner wall of the stationary casing. The drainage outlet may be arranged such that contaminants, such as oil, are drained through a bearing arranged for journaling the rotating member.

The outlet for cleaned gas extends through a wall of the stationary casing, such as through a lower portion of the surrounding side wall of the stationary casing. The gas outlet conduit may extend through the stationary casing to a radial position that is larger than the radial position of the outer wall of the stationary casing, or to a radial position that is the same as the radial position of the outer wall of the stationary casing.

The gas outlet may be a generally cylindrical tube or have another cross section, such as an oval cross section.

During operation, gas to be cleaned may be directed centrally through the plurality of separation members, such as centrally through the stack of separation discs. In such a set-up, the rotating member may further define a central space formed by at least one through hole in the separation members. This central space is connected to the gas inlet and configured to convey the gas to be cleaned from the gas inlet to the interspaces between the separation members, such as between the interspaces between the discs of a stack of separation discs. A separation disc that may be used as separation member may comprise a central, essentially flat portion perpendicular to the axis of rotation. This portion may comprise the through holes that form part of the central space.

Thus, the centrifugal separator may be configured to convey gas to be cleaned, such as crankcase gases, from the gas inlet into a central portion of the rotating member. In this manner the crankcase gases may be “pumped” from the central portion of the rotating member into the interspaces between the separation discs in the stack of separation discs by the rotation of the rotating member. Thus, the centrifugal separator may work according to the concurrent flow principle, in which the gas flows in the disc stack from a radial inner part to a radial outer part, which is opposite to a separator operating according to the counter-current flow principle, in which the gas is conducted into the separation space at the periphery and conveyed towards a central part of the separation space.

The drive member may for example comprise a turbine wheel, rotated by means of an oil jet from the lubrication oil system of the combustion engine or a free jet wheel comprising a blow-back disk. However, the drive member may also be independent of the combustion engine and comprise an electrical motor, a hydraulic motor or a pneumatic motor.

As an example, the stationary casing may comprise an upper and lower surrounding annular side wall. The lower surrounding side wall may be cylindrical in shape and may be joined to the upper surrounding side wall e.g. by welding or by fastening members such as screws. This facilitates mounting of the rotating member inside the stationary casing. The lower surrounding annular side wall may extend down to a lower end wall of the stationary casing. The lower end wall may thus be the lower wall extending in the radial direction, such as in the radial plane or with a small angle relative the radial plane. In some embodiments, also the lower end wall is part of the lower surrounding annular side wall.

As discussed above, the separated contaminants may comprise oil that after separation from the gas in the separation members are thrown against the inner wall of the stationary casing. Such oil droplets may trickle down the inner wall by means of gravity and be guided to the drainage outlet.

The further module can be any module being arranged in connection to the stationary casing, such as a gas inlet module, a gas outlet module and/or the drive unit of the centrifugal separator.

The compression seal may be any type of seal that is able to compress while subject to a certain amount of force being applied to the seal.

The elongated flap may be an element having an elongated shape with a narrow cross section.

The recess may be a cavity shaped in a mating part of the elongated flap such that an indentation having a corresponding form as the flap being shaped. Thereby the elongated flap can fit into the cavity.

The compression force sealing can be defined as the interaction between the elongated flap and the recess, wherein the interaction is created by the surfaces of the flap and the recess being in contact with each other.

In embodiments, the flap in the unsealed state may have an extension with a specific length (L) in the direction of the second axis (Y) and a specific width (W), wherein the length (L) may be larger than the width (W).

The flap can be defined as a skirt with a short extension or a sleeve like part with an elongate and narrow cross section area.

As an example, the flap may have a relation between the flap width and the length (W/L) being ⅕.

The length (L) may be 5 times longer than the width (W), or the length (L) may be 6, 8, 10, or 12 times the width (W).

In embodiments of the first aspect, the flap in the unsealed state may be tapering such that the flap width (W) being smallest at its distal end.

The flap may be arranged in a body, which is a solid obstacle such as a rigid element, preferably ring-shaped. The flap may have a pointed shape so that the width is most narrow at the end farthest from the body. The end farthest from the body may be defined as the distal end. The value of the width (W) of the flap may be defined where the flap has its broadest width, close to the body.

In embodiments, the flap can be made of an elastic material.

This can be some type of plastic or harder type of rubber. Thereby, a flexible compression seal is achieved.

In embodiments of the first aspect, the at least one recess can be arranged in the stationary casing and the at least one elongated flap can be arranged in said further module.

Alternatively, the at least one elongated flap may be arranged in the stationary casing and the at least one recess may be arranged in said further module.

Thereby, the flap can be arranged in the stationary casing and the recess may be applied in the further module, or vice versa.

In embodiments, the flap in the unsealed state may have a cross section area that is larger than the cross section area of the recess, wherein the cross section is taken along the second axis (Y).

This enables an enhanced sealing capacity.

In embodiments, the compression seal may comprise two recesses with a continuous extension around a second axis (Y) and two elongated flaps with a continuous extension around the second axis (Y), wherein the flaps may be arranged in the recesses such that a compression force sealing is achieved between the flap surfaces and the recess surfaces.

The flaps may be arranged around a protrusion being located centrally within the recess, wherein the distance between the distal ends of the flaps in the unsealed state is shorter than the width of the protrusion.

In embodiments, the further module is selected from the gas inlet module, the gas outlet module and the drive unit of the centrifugal separator.

When the further module is selected being the gas inlet module and the inlet is centred around the first axis of rotation (X), the first axis of rotation (X) and the second axis (Y) may be interpreted as being one common axis. The gas inlet module may then be connected to an upper opening wall section. Thereby, the compression seal seals between the inlet wall section and the upper opening wall section. The inlet wall section may have a substantially cylindrical shape and may delimit the gas inlet towards the surroundings. The upper opening wall section may connect to the inlet wall section such that the upper opening wall section and the inlet wall section extend and are centred along a common longitudinal axis such as the first axis of rotation (X). The upper opening wall section connects to the upper wall of the stationary casing.

When the further module is selected being the gas outlet module, the compression seal may seal between the lower side wall and the gas outlet wall section. The lower side wall is the lower part of the surrounding side wall of the stationary casing and the gas outlet wall section defines the tube of the outlet for cleaned gas.

When the further module is selected being the drive unit, the compression seal may seal between the drive unit and the lower end wall. The lower end wall defines the lowermost part of the stationary casing.

In embodiments of the first aspect, the centrifugal separator may be free of any O ring for sealing between the stationary casing and the further module.

Consequently, in embodiments of the first aspect, the centrifugal separator contains no additional separate rubber sealing, so it is free of any loose piece of seal.

The stationary casing and the further module may be fitted together by means of at least one separate fastening means.

A separate fastening means can easily be replaced if it is worn out. The fastening means can be one or several snap fit connections, one or a plurality of screws, or any other type of fastening means.

In embodiments, the compression seal can be annular. The seal may also be oval or may have any other geometrical shape that is suitable to be used as a seal.

Alternatively, in embodiments, the compression seal can comprise one recess with a continuous extension around a second axis (Y) and two elongated flaps with a continuous extension around the second axis (Y), wherein the flaps are arranged in the recess such that a compression force sealing is achieved between the flap surfaces and the recess surface.

Thereby the flaps may be in contact with the outer walls of the recess.

The plurality of separation members can be a stack of separation discs, such as a stack of frustoconical separation discs. Such discs may have an outer radius and an inner radius, thus forming a central opening in the disc. The frustoconical separation discs may comprise a flat portion that extend perpendicularly to the first axis of rotation (X), and a conical portion that extend outwardly and downwardly or upwardly from the flat portion. Openings in the flat portion may form part of a central space within the centrifugal separator into which gas to be cleaned is guided from the gas inlet. Thus, gas to be cleaned may be guided into the central space and then to the interspaces formed between the discs in the disc stack. As a complement, or alternative, the central space may also be formed radially within the inner radius of the discs.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 shows a schematic drawing of a cross section of an embodiment of a centrifugal separator for cleaning gas.

FIG. 2 shows a cross section along the second axis (Y) of a first embodiment of a compression seal, taken at A1 in FIG. 1. The figure shows before and after the two parts are put together.

FIG. 3 shows a cross section along the second axis (Y) of a first embodiment of a compression seal, taken at A2 in FIG. 1.

FIG. 4 shows a cross section along the second axis (Y) of a first embodiment of a compression seal, taken at A3 in FIG. 1.

FIG. 5 shows a perspective view of a second part of a compression seal.

FIG. 6 shows a cross section along the second axis (Y) of a second embodiment of a compression seal.

FIG. 7 shows a cross section along the second axis (Y) of a third embodiment of a compression seal.

### DETAILED DESCRIPTION

The centrifugal separator according to the present disclosure will be further illustrated by the following description with reference to the accompanying drawings.

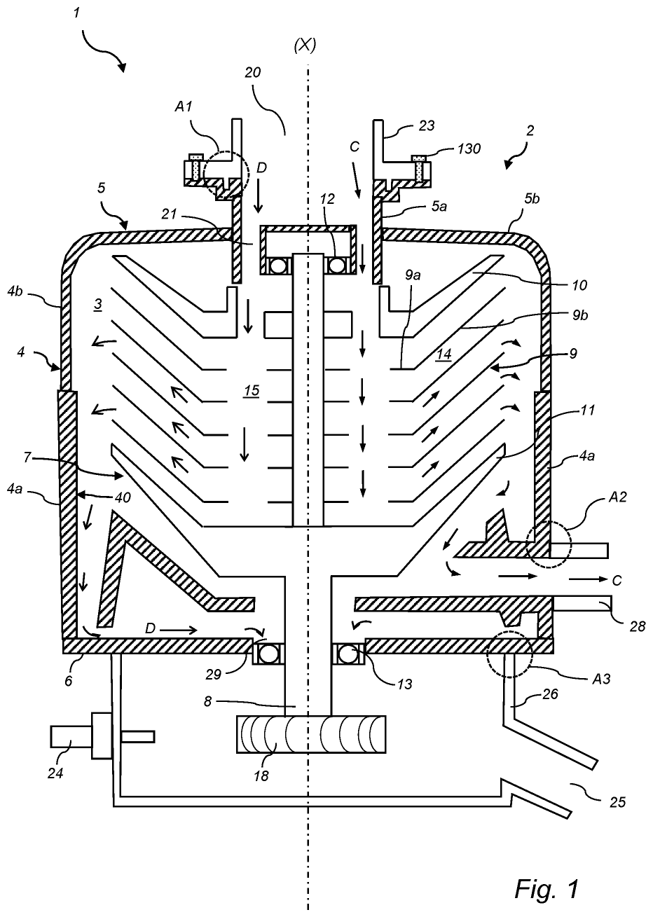

FIG. 1 shows a cross section of a centrifugal separator 1 according to the present disclosure. The centrifugal separator 1 comprises a stationary casing 2, which is configured to be mounted to a combustion engine (not disclosed), especially a diesel engine, at a suitable position, such as on top of the combustion engine or at the side of the combustion engine.

It is to be noted that the centrifugal separator 1 is also suitable for cleaning gases from other sources than combustion engines, for instance the environment of machine tools which frequently contains large amounts of liquid contaminants in the form of oil droplets or oil mist.

The stationary casing 2 encloses a separation space 3 through which a gas flow is permitted. The stationary casing 2 comprises, or is formed by, a surrounding side wall 4, an upper wall 5 and a lower end wall 6. The surrounding side wall 4 comprises an upper 4b and a lower 4a surrounding annular side wall, attached to each other e.g. via welding or screws (not shown). There may also be a sealing member (not shown), such as an O ring, between the upper 4b and lower 4a surrounding annular side wall. The upper wall 5 comprises an upper end wall 5b and an upper opening wall section 5a.

The centrifugal separator 1 comprises a rotating member 7, which is arranged to rotate around a first axis (X) of rotation. It should be noted that the stationary casing 2 is stationary in relation to the rotating member 7, and preferably in relation to the combustion engine to which it may be mounted.

The stationary casing 2 has a radius from the first axis (X) of rotation to the surrounding side wall 4 that is constant at least with respect to a major part of the circumference of the surrounding side wall 4. The surrounding side wall 4 thus has a circular, or substantially, circular cross section in a radial plane.

The rotating member 7 comprises a rotatable shaft, i.e. spindle 8 and a stack of separation discs 9 attached to the spindle 8. All the separation discs of the stack 9 are provided between a top disc 10 and a lower end plate 11.

The spindle 8, and thus the rotating member 7, is rotatably supported in the stationary casing 2 by means of an upper bearing 12 and a lower bearing 13, the bearings being arranged one on each axial side of the stack of separation discs 9. However, the bearings could for example both be arranged axially below or above the stack 9 of separation discs.

The separation discs of the disc stack 9 are frusto-conical and extend outwardly and upwardly from the spindle 8. The separation discs thus comprise a flat portion 9a, which extend perpendicularly to the first axis of rotation (X), and a conical portion 9b, that extend outwardly and upwardly from the flat portion 9a. It should be noted that the separation discs also could extend outwardly and downwardly, or even radially.

The separation discs of the stack 9 are provided at a distance from each other by means of distance members (not disclosed) in order to form interspaces 14 between adjacent separation discs 9, i.e. an interspace 14 between each pair of adjacent separation discs 9. The axial thickness of each interspace 14 may e.g. be in the order of 0.5-2 mm, such as 1-2 mm.

The separation discs of the stack 9 may be made of plastic or metal. The number of separation discs in the stack 9 is normally higher than indicated in FIG. 1 and may be for instance 50 to 100 separation discs 9 depending on the size of the centrifugal separator.

The centrifugal separator 1 comprises an oil nozzle 24 arranged for being connected to an engine oil circuit of an internal combustion engine. During running of the internal combustion engine, oil is pumped through the oil nozzle 24 onto a turbine wheel 18, which is arranged in turbine housing 26. Since turbine wheel 18 is connected to the spindle 8, the rotating member 7, and thus the stack of separation discs 9, also rotate upon rotation of wheel 18. As an alternative, the centrifugal separator 1 may comprise an electric motor arranged to rotate the spindle 8 and rotating member 7. As a further alternative, the centrifugal separator 3 may comprise a turbine wheel connected to the spindle 8, where the turbine wheel is arranged to be driven by exhaust gases from the internal combustion engine to rotate the spindle 8 and the rotating member 7. The rotating member 7 may also be arranged for being rotated by a mechanical drive unit. Thus, the centrifugal separator may comprise a mechanical drive unit for rotating the rotating member.

The rotating member 7 defines a central space 15. The central space 15 is formed by a through hole in each of the separation discs 9. In the embodiments of FIG. 1, the central space 15 is formed by a plurality of through holes, each extending through the top disc 10 and through each of the separation discs 9, but not through the lower end plate 11. The through holes are arranged in the flat portions 9a of the separation discs.

The gas inlet 20 is for the supply of the gas to be cleaned. The gas inlet 20 extends through the stationary casing 2, and more precisely through upper wall 5. The gas inlet 20 is formed by an axially extending inlet conduit.

The gas inlet 20 is surrounded by an inlet wall section arranged in connection to the upper opening wall section 5a, which is arranged in connection to the upper end wall 5b of the stationary casing 2. The inlet wall section is comprised in a gas inlet module 23.

Through channels 21 are in fluid connection with central space 15 and are arranged radially outside the upper bearing 12. Thus, the gas inlet 20 communicates with the central space 15 so that the gas to be cleaned is conveyed from the inlet 20 via the central space 15 to the interspaces 14 of the stack of separation discs 9. The gas inlet 20 is configured to communicate with the crankcase of the combustion engine, or any other source, via the inlet conduit permitting the supply of crankcase gas from the crankcase to the gas inlet 20 and further to the central space 15 and the interspaces 14 as explained above.

The centrifugal separator 1 comprises a drainage outlet 29 arranged in the lower portion of the stationary casing 2 and configured to permit discharge of liquid contaminants separated from the gas. The drainage outlet 29 is in this embodiment in the form of through holes arranged in the lower end wall 6 so that separated liquid contaminants flow through the lower bearing 13 as they are drained from the separation space 3 to the turbine housing 26. The separated oil, and other particles and/or substances, is led to an oil outlet 25 of the centrifugal separator 1, which together with oil from the oil nozzle 24 used to drive the wheel 18, may be led back to the engine oil circuit of an internal combustion engine.

The gas outlet module 28 of the centrifugal separator 1 is arranged through the stationary casing 2 and is configured to permit discharge of cleaned gas. The gas outlet module 28 can be a tube.

During operation of the centrifugal separator as shown in FIG. 1, the rotating member 7 is kept in rotation by the oil nozzle 24 supplying oil against the wheel 18. As an example, the rotational speed may be in the range of 7.500-12.000 rpm.

Contaminated gas, e.g. crankcase gas from the crankcase of an internal combustion engine, is supplied to the gas inlet 20. This gas is conducted further into the central space 15 and from there into and through the interspaces 14 between the separation discs of the stack 9. As a consequence of the rotation of the rotating member 7 the gas is brought to rotate, whereby it is pumped further on radially outwardly through gaps or interspaces 14.

During the rotation of the gas in the interspaces 14, solid or liquid particles such as oil suspended in the gas are separated therefrom. The particles settle on the insides of the conical portions 9b of the separation discs and slide or run after that radially outwardly thereon. When the particles and/or liquid drops have reached out to the radial outer edges of the separation discs 9, they are thrown away from the rotating member 7 and hit the inner surface 40 of the surrounding side wall 4. Separated oil particles may form a film on the inner surface of the stationary casing 2. From there, oil may be pulled by gravity downwardly to bottom end wall 6 and then leave the separation space 3 through the drainage outlet 29. For this, the inner wall of the bottom end wall 6 may be tilted radially inwards, so that oil leaving the surrounding inner wall of the stationary casing 2 may be pulled by gravity towards drainage outlet 29. The path of the contaminants in the gas is schematically illustrated by arrows “D” in FIG. 1.

Cleaned gas freed from particles and exiting from the stack of separation discs 9 leaves the stationary casing 2 through the gas outlet tube 28. The path of the gas through the centrifugal separator 1 is schematically shown by arrows “C” in FIG. 1.

In FIG. 1 specific locations A1, A2, A3 have been marked as places for a compression seal 100. These are example areas, so a compression seal according to the present disclosure may be placed in any other part of the centrifugal separator benefitting from a compression seal. The compression seal 100 is placed between the stationary casing 2 and a further module. The further module can be the gas inlet module 23, the gas outlet module 28, the drive unit 26 or any other module connecting to the casing, which would need sealing.

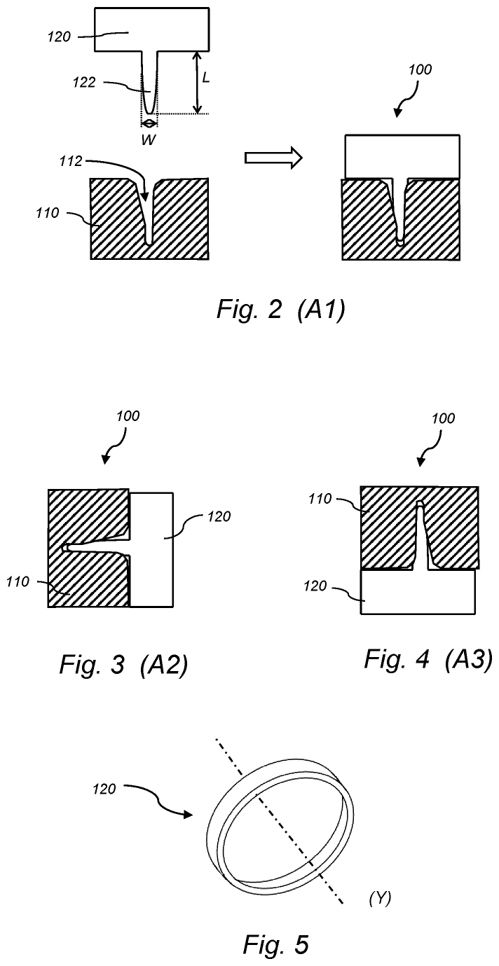

FIG. 2 discloses a first embodiment of a compression seal 100 taken from A1 in FIG. 1. This location of the seal achieves a sealing between the casing 2 of the centrifugal separator and the gas inlet 20. The figure shows a cross section taken along the longitudinal axis (Y), see FIG. 5. The location of the seal 100 results in that the first axis (X) and the second axis (Y) coincide so they will be seen as one common axis, since the first longitudinal axis (X) is centred in the inlet 20.

More specifically, the compression seal 100 seals between the upper opening wall section 5a and the gas inlet module 23 comprising a wall section. A first part 110 and a second part 120 represent the upper opening wall section 5a and the inlet wall section in the figure.

The figure shows before and after the first 110 and the second 120 parts are put together. The first part 110 has an elongated recess 112 into which a flap 122 of the second part 120 is to be matched such that the two parts are joined together as a tight coupling. Before the flap 122 is fit into the recess, when the flap is in an unsealed state, the flap has an elongated cross section taken along the second axis (Y), wherein the flap has a length L having a larger value than the width W of the flap.

As disclosed in FIG. 1, a separate fastening means 130 keeps the inlet wall section 23 and the upper opening wall section 5a fastened to each other. The fastening means can be one or several snap fit connections, one or a plurality of screws, or any other type of bonding such as a welded seam. Such fastening means can also be applied to the compression seal being located elsewhere in the centrifugal separator, such as in A2 or A3.

FIG. 3 discloses a first embodiment of a compression seal 100 taken from A2 in FIG. 1. This location of the seal achieves a sealing between the casing 2 of the centrifugal separator and the gas outlet tube 28. The figure shows a cross section taken along the longitudinal axis (Y), see FIG. 5. The figure shows when the first 110 and the second 120 parts are put together, wherein the two parts 110 and 120 represent the lower side wall 4a and the gas outlet tube 28.

FIG. 4 discloses a first embodiment of a compression seal 100 taken from A3 in FIG. 1. This location of the seal achieves a sealing between the casing 2 of the centrifugal separator and the drive unit 26. The figure shows a cross section taken along the longitudinal axis (Y), see FIG. 5. The figure shows when the first 110 and the second 120 parts are fitted together, wherein the two parts 110 and 120 represent the lower end wall 6 and the drive unit 26.

The compression seal 100 of the first embodiment disclosed in FIGS. 3, 4 and 5 may be designed so that the flap 122 either is broader, i.e. has a larger width W, than the recess 112 or so that the flap 122 has a length L that is longer than the length of the recess 112, in the unsealed state. This means that in the unsealed state the cross section taken along the second axis (Y) gives an area of the flap 122 being larger than the area of the recess 112. Thereby a compression force sealing is achieved. The flap 122 can be defined as a skirt with a short extension or a sleeve like part with an elongate and narrow cross section area.

FIG. 5 shows a perspective view of the second part 120 of the compression seal 100. The seal may be annular and is centred around a second longitudinal axis (Y). The seal may also be oval or may have any other geometrical shape that is suitable to use as a seal.

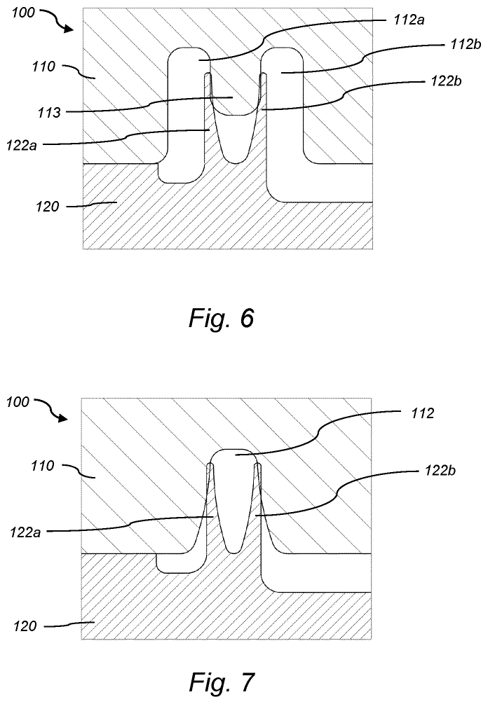

FIG. 6 shows a second embodiment of a compression seal 100 taken as a cross section along the second axis (Y) in FIG. 5. The first part 110 comprises two recesses 112a, 112b with a protrusion 113 in between the two recesses. Alternatively, the two recesses can be located separately with a full wall portion in between (not shown). The second part 120 comprises two flaps 122a, 122b. Each flap has a width that is broadest closest to the body of the second part 120 with a width that becomes narrower further away from the body, so that the width of the two flaps is smallest at their distal ends. When the flaps 122a, 122b are in the unsealed state i.e., before entered into the recesses 112a, 112b the distance between the two distal ends is smaller than the width of the protrusion 113, from the side of the protrusion being located in the first recess 112a to the side of the protrusion being located in the second recess 112b. So, when mating the first and second parts 110, 120 together the first and the second flap 122a, 122b are arranged in the first and the second recess 112a, 112b, respectively on the surfaces connecting to the protrusion 113. Thereby, the flaps 122a, 122b create a compression force sealing by being in tight contact with the surface of the recesses 112a, 112b.

FIG. 7 shows a third embodiment of a compression seal 100 taken as a cross section along the second axis (Y) in FIG. 5. The first part 110 comprises one recess 112 and the second part 120 comprises two flaps 122a, 122b. Both flaps have an elongate and narrow cross section area with a width that becomes smaller further away from the body of the second part 120. In the unsealed state of the second part 120 the distance between the flaps 122a, 122b at the distal end is larger than the width of the recess 112, so that in the sealed state each flap engages with the wall surface of the recess 112 in order to create a compression sealing force.

The embodiments disclosed in FIGS. 6 and 7 may be arranged in FIG. 1 at any of A1, A2, A3 or any other suitable place where sealing is needed within the centrifugal separator.

The first 110 and the second part 120 of the compression seal 100 preferably have the same inner diameter.

The invention is not limited to the embodiment disclosed but may be varied and modified within the scope of the claims set out below. The invention is not limited to the orientation of the first axis of rotation (X) and the second axis of rotation (Y) disclosed in the figures. The term “centrifugal separator” also comprises centrifugal separators with a substantially horizontally oriented axis of rotation. In the above the inventive concept has mainly been described with reference to a limited number of examples. However, as is readily appreciated by a person skilled in the art, other examples than the ones disclosed above are equally possible within the scope of the inventive concept, as defined by the appended claims.

1. A centrifugal separator for cleaning gas containing contaminants, the centrifugal separator comprising
a stationary casing, enclosing a separation space through which a gas flow is permitted,
a gas inlet arranged to permit supply of the gas to be cleaned into the stationary casing,
a rotating member comprising a plurality of separation members arranged in the separation space and being arranged to rotate around a first axis of rotation,
a gas outlet arranged to permit discharge of cleaned gas out from the stationary casing,
a drainage outlet arranged in the stationary casing and configured to permit discharge of liquid contaminants that have been separated from the gas out from the stationary casing,
a drive unit comprising a drive member for rotating the rotating member, and
a further module,
wherein the centrifugal separator further comprises
a compression seal arranged for sealing the stationary casing against said further module and comprising at least one elongated flap and at least one recess, the compression seal having a continuous extension around a second axis, and
wherein said at least one elongated flap is arranged in said at least one recess such that a compression force sealing is achieved by means of the flap surface being in contact with the recess surface.

2. The centrifugal separator according to claim 1, wherein the flap in the unsealed state has an extension with a specific length in the direction of the second axis and a specific width, wherein the length is larger than the width.

3. The centrifugal separator according to claim 2, wherein the flap has a relation between the flap width and length being ⅕.

4. The centrifugal separator according to claim 2, wherein the flap in the unsealed state is tapering such that the flap width being smallest at its distal end.

5. The centrifugal separator according to claim 1, wherein the flap is made of an elastic material.

6. The centrifugal separator according to claim 1, wherein the at least one recess is arranged in the stationary casing and the at least one elongated flap is arranged in said further module.

7. The centrifugal separator according to claim 1, wherein the at least one elongated flap is arranged in the stationary casing and the at least one recess is arranged in said further module.

8. The centrifugal separator according to claim 1, wherein the flap in the unsealed state has a cross section area that is larger than the cross section area of the recess, wherein the cross section is taken along the second axis.

9. The centrifugal separator according to claim 1, wherein the compression seal comprises two recesses and two elongated flaps, with a continuous extension around the second axis, wherein the flaps are arranged in the recesses such that a compression force sealing is achieved between the flap surfaces and the recess surfaces.

10. The centrifugal separator according to claim 1, wherein the further module is selected from a gas inlet module, a gas outlet module module and the drive unit.

11. The centrifugal separator according to claim 1, wherein the centrifugal separator is free of any O ring for sealing between the stationary casing and the further module.

12. The centrifugal separator according to claim 1, wherein the stationary casing and the further module are fitted together by means of at least one separate fastening means.

13. The centrifugal separator according to claim 1, wherein the compression seal is annular.

14. The centrifugal separator according to claim 3, wherein the flap in the unsealed state is tapering such that the flap width being smallest at its distal end.

15. The centrifugal separator according to claim 2, wherein the flap is made of an elastic material.

16. The centrifugal separator according to claim 3, wherein the flap is made of an elastic material.

17. The centrifugal separator according to claim 4, wherein the flap is made of an elastic material.

18. The centrifugal separator according to claim 2, wherein the at least one recess is arranged in the stationary casing and the at least one elongated flap is arranged in said further module.

19. The centrifugal separator according to claim 3, wherein the at least one recess is arranged in the stationary casing and the at least one elongated flap is arranged in said further module.

20. The centrifugal separator according to claim 4, wherein the at least one recess is arranged in the stationary casing and the at least one elongated flap is arranged in said further module.
